(19) United States
(12) Patent Application Publication
(10) Pub. No.: US 2006/0161788 A1
(43) Pub. Date: Jul. 20, 2006

(54) Full color spectrum object authentication methods and systems

(76) Inventors: Ken Turpin, Delta (CA); Christopher Paul Mullen, Vancouver (CA); Paul Gerhart Kroker, Surrey (CA)

Correspondence Address: DUNLAP, CODDING & ROGERS P.C., PO BOX 16370, OKLAHOMA CITY, OK, 73113, US

(21) Appl. No.: 11/264,626

(22) Filed: Nov. 1, 2005

Related U.S. Application Data
(60) Provisional application No. 60/623,881, filed on Nov. 1, 2004.

(51) Int. Cl. H04K 1/00

(52) U.S. Cl. 713/186

(57) ABSTRACT

A system for authenticating sampled objects including a database, a plurality of spectrum measuring devices, and a plurality of computers. The database stores a plurality of reference patterns measured from known reference objects. Each of the spectrum measuring devices measures a region of respective sampled objects so as to produce spectral content information identifying the sampled objects. The spectral content information includes information indicative of colors inside the visible spectrum of the human eye. The computers have access to spatial analysis software. The computer receives the spectral content information identifying the sampled object and provides the spectral content information to the spatial analysis software to generate a unique measured pattern. The spatial analysis software compares the unique measured pattern with the reference patterns stored in the database, and outputs signals indicative of matches between the unique measured pattern with the reference pattern within a tolerance level whereby the colors of the regions of the sampled objects are utilized to authenticate the sampled objects.

### CROSS-REFERENCE TO RELATED PATENT APPLICATIONS

The present patent application claims priority to the provisional patent application identified by U.S. Ser. No. 60/623,881, filed on Nov. 1, 2004 and entitled “FULL COLOR SPECTRUM OBJECT AUTHENTICATION METHODS AND SYSTEMS.” The present patent application also claims priority to the provisional patent application filed on Oct. 31, 2005 and entitled “FULL COLOR SPECTRUM OBJECT AUTHENTICATION METHODS AND SYSTEMS”. The entire content of both of the provisional patent applications is hereby expressly incorporated by reference in their entireties.

### BACKGROUND OF THE INVENTION

Expansive measures taken to insure public safety and security are necessary efforts of governments and business, especially in view of the current world situation. Areas such as national security, document authentication and forgery detection, product protection and tampering prevention, and medical diagnostics have several vulnerabilities, which result in billions of dollars a year in losses. For example, local and international criminal enterprises are increasingly using fictitious securities and negotiable instruments to defraud the government, individuals, corporations and financial institutions. Such bogus instruments have been repeatedly used to obtain government benefits, setup pension funds and retirement accounts, underwrite loans, serve as insurance collateral, and defraud individual investors, retailers, and consumers.

A new generation of fraudulent alteration or counterfeiting emerged when computerized color laser copiers became capable of high-resolution copying. Such technological advances facilitate the modification of documents, and even the creation of false documents without the benefit of an original. Advanced design, copying and publishing technology enhance the capability to produce high-quality counterfeit passports, currency, and financial instruments such as commercial checks, travelers' checks and money orders. Such documents are easily produced with a quality, which for the common observer, is indistinguishable from that of authentic documents.

Effects of such fraudulent activities can be seen world wide. For example, the percentage of counterfeit U.S. currency passed in the United States, which were produced using inkjet color copiers, has jumped from 0.5% in 1995 to 43% in 1998. During the same period, the value of Canadian counterfeit bank notes passed and seized in Canada was $5.2 million, double that of the previous year. In fiscal year 2001, about 39% of the $47.5 million in seized counterfeit money that entered circulation in the United States was made using computers or scanners. Thus, one can expect that as circulation of U.S. currency increases, especially overseas, so will the threat of counterfeiting by domestic and foreign organized crime groups.

While vigorous anti-counterfeiting measures and arrests of targeted operations have caused the amount of counterfeit currency to drop precipitously, with passed and seized counterfeit $100 bills in the United States falling from $126 million to $53 million between 1994 and 1997, there is still a need for additional measures to aid in document forgery prevention and detection.

Another example of an affected area is the finance's industry. Financial fraud has become more prevalent in recent years as both local and international criminals take advantage of the availability of significantly greater personal and corporate financial information which is readily exploitable through computer technology and access devices, such as credit cards, debit cards and smart cards. As a result, businesses and individuals suffer increasing financial losses from insurance and credit card fraud. Based on potential losses, major U.S. credit card issuers suffered fraud losses in excess of $2 billion in 1996, about one-third of which occurred because of international fraudulent activity. The Association of Certified Fraud Examiners estimates financial losses in the United States from fraud schemes by domestic and international criminals at more than $200 billion per year. In 1998, the Canadian Bankers Association reported losses due to credit card frauds totaling over $142 million, with one half of those losses due to counterfeiting.

Additionally, many security risks result from falsified identification documents, such as driver licenses, state IDs, military IDs, school or employee IDs, passports, birth certificates, naturalization certificates, etc. Concerns relating to such areas can be seen in legislative efforts at both the national and state level. For example, new laws, penalties and issuance standards aim to improve the security of State-issued drivers' licenses. These measures aim to combat the manufacturing, distribution, marketing, sale, procurement, or use of altered or counterfeit driver licenses. For example, states are establishing minimum security features to make driver licenses and ID cards more resistant to tampering, altering or counterfeiting. New technologies are being developed to authenticate drivers' identities in an effort to improve security and combat fraud. These new tools give law enforcement officials additional ways to fight identity theft and fraud, as well as deter fraud related terrorist activity. Other efforts include tightening current disclosure procedures and prohibiting displays of social security numbers on driver licenses. This helps ensure protection of an individual's privacy and confidential information.

Once issued, driver licenses or other identification cards are used to open bank accounts, secure credit cards, obtain social security cards, acquire employment, secure residences, etc. Because driver licenses and state identification cards are such an important part of everyday life in America and elsewhere, it is clear that measures to curb their use to further criminal schemes deserves serious consideration. One particular area of concern is the use of these forms of identification in obtaining other privileged documents or access to certain locales or resources. For example, to acquire a U.S. passport for the first time, an applicant must provide evidence of identity—in other words, they must show documentation such as a birth certificate, a valid government-issued identification document that includes a photograph and/or physical description of the holder (e.g., state driver license, state identification cards, military identification, etc.), or in some instances a non-government identification (e.g., company or school identification). Those attempting to obtain original U.S. passports fraudulently must generally first acquire one or more of these documents. The most common form of identity evidence presented with a passport application is a state-issued driver license or identity card.

An example of the importance of verifying and authenticating identification documents can be seen in conjunction with the efforts taken by the government and the airline industry to reduce vulnerability to terrorist incidents by increasing security at airports and related facilities. When travelers go to buy an air travel ticket today, they are asked to identify themselves with just a photo ID. However, what ensures that this is the person's true identity? What safeguards are in effect to keep illegal or unauthorized people from using false identification to obtain a ticket or once obtained, give that ticket to someone else to board an aircraft? Thus, there is a great need for solid validation of a person's identity at each stage of the process to secure aviation travel. Such multi-stage identification verification is also needed in other security-risk areas as well.

Identification and security concerns are also present in the health care industry. For example, the Health Insurance Portability and Accountability Act of 1996, commonly known as HIPAA, mandates that health plans and health care providers must obtain written or electronic approval from patients or beneficiaries for use and disclosure of health information, even if the information is related to routine purposes such as treatment or payment. As such, the plans and providers are required to maintain privacy-conscious business practices to insure that only the necessary minimum amount of health and patient information is disclosed. Medical records must be kept in an adequately protective environment and employees must be diligently trained on protection and security procedures. Such security standards in some cases represent a significant change in IT retooling and operational procedures in many healthcare and related organizations or enterprises regarding the handling of data transactions and obligations of healthcare providers, health plans, and clearing houses associated with the rights of patients.

The HIPAA requires an enterprise to implement and enforce a policy defining the procedures and means for safeguarding the access, transmissions, transactions, management, and storage of individuals' health information within the enterprise, and also between enterprises. One current standard used is Unique Identifiers (UI's). The UI's are 10-digit numbers that allow the patient to give approval for the accessing, transmission and reviewing of the patient's private data. If the UI given to the provider does not validly identify the patient, no transaction will be allowed to process. If identified, the process can continue and the patient can receive treatment or needed pharmaceuticals, or precede with insurance claims transactions. While UI's offer some level of security, there is a need for other systems that enterprises can use to identify and verify patient identity and authorization in compliance with HIPAA security standards.

Another-area with significant safety, security, and financial risks is the product manufacturing industry. Product tampering and false brand labeling or “knock offs” can lead to consumer dissatisfaction or injury, as well as further loss profits due to unfair competition practices. Thus, there is a continuing need for new brand protection and monitoring tools that manufactures can use to identify and authenticate their products.

As can be seen, there is a continuing need to develop new and improved solutions that can contribute to the safety and security of everyday activities. Various technologies exist in the marketplace which address such problems. These technologies can be separated into two broad categories: legacy systems and biometrics. Legacy systems include for example bar codes and serial numbers, watermarking, holograms, ultraviolet ink, color shifting ink, and fine-line and micro-printing techniques. Biometrics include for example analysis of biological characteristics associated with fingerprints, DNA, facial features, speech, signatures, hand geometry, and iris patterns.

While such technologies offer increased security and safety features, they can be overly complex and time consuming for general applications and/or require additions or modifications to the existing object to be monitored. As such, there is still a need for an effective and efficient authentication system offering real-time and non-intrusive processing applications. It is to such an apparatus and method that the present invention is directed.

### BRIEF DESCRIPTION FOR THE SEVERAL VIEWS OF THE DRAWINGS

FIG. 1 is a diagram of an object authentication system constructed in accordance with the present invention.

FIG. 2 is a chart illustrating the electromagnetic spectrum.

FIG. 3 is a perspective view of an exemplary object.

FIG. 4 is a graphical representation of a measured pattern associated with the object shown in FIG. 3, which is generated in accordance with the present invention.

FIG. 5 is another view of the graphical representation shown in FIG. 4.

FIG. 6 is a graphical representation of an exemplary longitudinal and latitudinal coordinate system.

FIG. 7 is a graphical representation of a view key associated with the measured pattern shown in FIG. 3, which is generated in accordance with the present invention.

FIG. 8 is a graphical representation of another view key associated with the measured pattern shown in FIG. 3, which is generated in accordance with the present invention.

FIG. 9 is an exemplary graphical user interface for displaying the comparison results of the object authentication system for the object shown in FIG. 3.

FIG. 10 is a perspective view of another exemplary object.

FIG. 11 is a graphical representation of a measured pattern associated with the object shown in FIG. 10, which is generated in accordance with the present invention.

FIG. 12 is a graphical representation of a view key associated with the measured pattern shown in FIG. 11, which is generated in accordance with the present invention.

FIG. 13 is an exemplary graphical user interface for displaying the comparison results of the object authentication system for the object shown in FIG. 10.

### DESCRIPTION OF THE INVENTION

While various technologies in the broad categories of legacy systems and biometrics offer applications in many securities, fraud/forgery prevention, identification, and medical diagnostic markets, to applicants' knowledge no one has developed a full color spectrum differentiating technology for object authentication. The present invention relates to a system and method for authenticating an object based on the spectral content, e.g., color, of a selected or arbitrary region of the object. Such a system and method is non-intrusive, can be adapted to perform within appropriate time restraints, and can be used independently or as a compliment to existing legacy and biometrics applications.

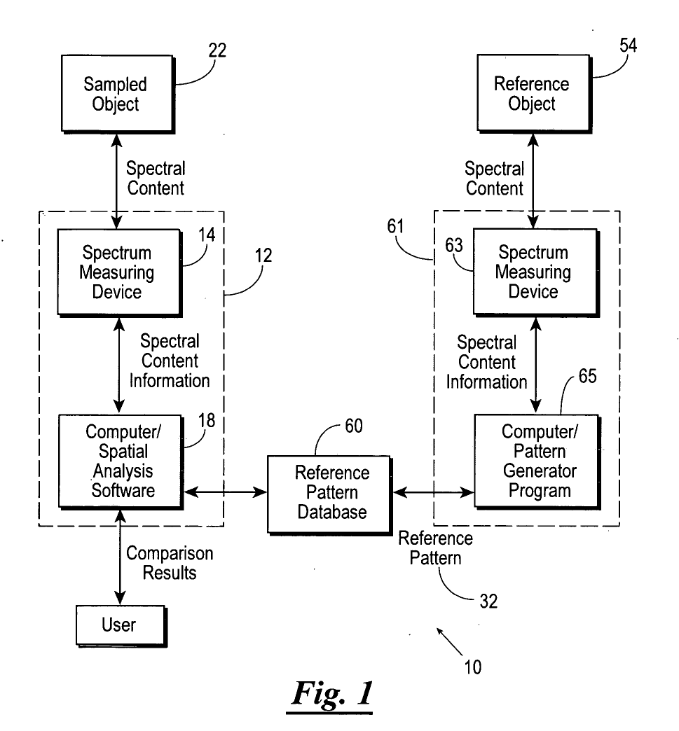

Referring now to the figures, and more particularly to FIG. 1, shown therein is a block diagram representation of one embodiment of a system 10 for full color spectrum object authentication, constructed in accordance with the present invention. The system 10 can be used to authenticate any object that has a physical presence, such as a photograph, a document, a colored product or mass, etc., so long as a spectral analysis can be conducted for at least a portion of the object in accordance with the present invention.

The system 10 includes an authentication apparatus 12 having a spectrum measuring device 14 and a computer 18 operating spatial analysis software. The spatial analysis software (or portions thereof) can be stored locally on a memory device of the computer 18, or the spatial analysis software (or portions thereof) can be stored remotely on a server so as to be accessible by the computer 18 (e.g., by accessing a local area network or an internet website).

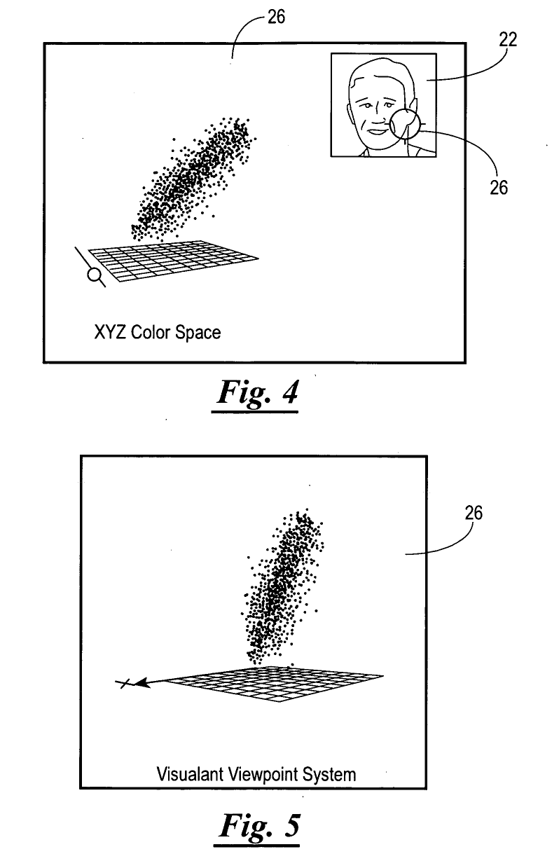

To authenticate a sampled object 22, the sampled object 22 is provided to the spectrum measuring device 14. The spectrum measuring device measures the spectral content, e.g., color, of a selected portion or region of the sampled object 22, and then outputs information indicative of the same to the computer 18. In general, the spatial analysis software operating on the computer 18 utilizes the spectral content information to generate a unique measured pattern 26 (see FIG. 4), which is then used by the spatial analysis software to determine the authenticity of the sampled object 22.

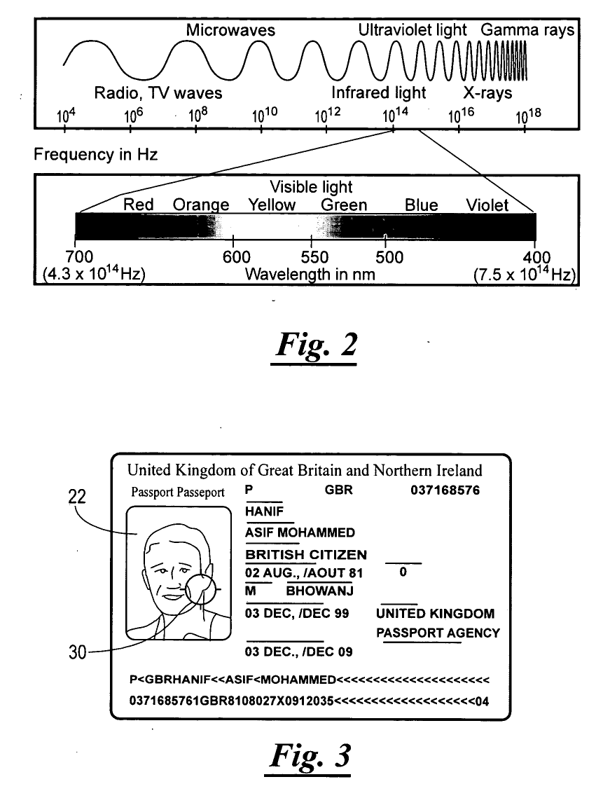

To authenticate the sampled object 22, the present invention contemplates performing a spectral analysis of electromagnetic frequencies inside the visible spectrum of the human eye, as well as outside the visible spectrum, namely in the infrared and ultraviolet frequencies. Shown in FIG. 2 is the electromagnetic spectrum. The area between approximately 400 and 700 nanometers is where the human visible light (color) resides on the electromagnetic spectrum. The infrared and ultraviolet areas of the electromagnetic spectrum are located adjacent to the boundaries of human vision. These areas are called “N-IR” and “N-UV”, respectively. Also, the spectral analysis is preferably performed using XYZ color space modeling. However, other color space models, such as for example LUV, can be used in accordance with the present invention. The measured pattern 26 provides a very accurate and fast way to compare spectral data from two sources. The color data or spectral content information in the measured pattern 26 is compared against a database record generated from an authentic object.

In one embodiment, the spectrum measuring device 14 includes a plurality of individual sensors (not shown), which preferably includes specialized narrow band N-IR and N-UV sensors. The plurality of sensors can be for example photodiodes or photomultipliers with different spectral sensitivities.

Preferably, the spectrum measuring device 14 measures the spectral content within a selected region 30 of the sampled object 22, such as shown for example in FIG. 3, wherein the sampled object 22 is shown as a passport photograph by way of illustration, and in FIG. 11, wherein the sampled object 22 is shown as a handbag product by way of illustration. The location and dimensions of the selected region 30 on the sampled object 22 is preferably controlled by the spatial analysis software. The selected region 30 can be essentially any dimension, and will generally depend on the accuracy and analysis time requirements for the system 10. For example, a circular area with a diameter of approximately 6 mm can contain millions of pieces of spectral information.

The spatial analysis software can allow the user to select the location and dimensions of the selected region 30 via at least one input device (not shown) connected to the computer 18. The at least one input device can be for example a keyboard, mouse, touch screen, keypad, joy stick, pen tablet, etc. Alternatively, the spatial analysis software can automatically select the location and/or dimension of the selected region 30. For example, a boundary or marking on the sampled object 22 can be used as a starting coordinate, and then the location can be set from the starting coordinate according to one or more predetermined values. Also, the spatial analysis software can automatically select the dimensions of the selected region 30, for example by using predetermined dimension values.

Once the location and dimensions of the selected region 30 are set, the spectrum measuring device 14 measures the spectral content of the selected region 30 and outputs information indicative of the same to the computer 18. The spectral content information is provided as input to the spatial analysis software, which then generates the measured pattern 26 for the selected region 30 of the sampled object 22. In one embodiment, to generate the measured pattern 26, a pattern generator program of the spatial analysis software isolates and identifies individual electromagnetic “nano” values within the selected region 30, and then determines how many of those values occur at an individual frequency or at multiple frequencies. These qualitative and quantitative nano values can be analyzed in various dimensions, and further from various viewpoints. For example, such data can be put in the form of numbers, or in the form of one, two or three-dimensional graphical representations (as discussed further below). As such, it can be seen that the system 10 of the present invention translates “invisible” spectral content information into “visible” representations which can be computationally exploited as well as outputted in a perceivable manner. Such capabilities provide the system 10 an innovative, accurate and time-efficient way to compare the spectral data from two sources.

More particularly, after receiving the spectral content information for the selected region 30 from the spectrum measuring device 14, the pattern generator program of the spatial analysis software converts the spectral content information into corresponding XYZ color space values. In other words, for each frequency unit measured by the spectrum measuring device 14, an XYZ value corresponding to the frequency is stored in a data file as one of a plurality of nano values.

The collection of nano values forms the unique measured pattern 26 of the selected region 30 of the sampled object 22. In one embodiment, the spatial analysis software uses the nano values to generate a three-dimensional graphical representation of the measured pattern 26 which is displayed to the user via at least one output device (not shown) connected to the computer 18. The at least one output device can be for example a monitor or printer. In one embodiment, the three-dimensional graphical representation of the measured pattern 26 is formed by plotting the nano values as points in a graphical XYZ coordinate system, as shown for example in FIG. 4. When more than one of the same frequency is present among the pattern values, the number of times the frequency value is repeated can be depicted visually to the user by the color of the plotted point in the graphical representation. Further, the nano values can be used to create other informative graphical representations. For example, a two dimensional chart (labeled as reference numeral 50 in FIG. 9 and as reference numeral 52 in FIG. 13 by way of illustration) can be generated and displayed which graphically represents the relationship of wavelength and reflectance amplitude.

In one embodiment, the measured pattern 26 is dynamically linked for search and comparison purposes. Generally, the measured pattern 26 is used to scan at least one database 60 (see FIG. 1) of known reference patterns 32 to determine whether the measured pattern 26 matches any of the reference patterns 32 within the database 60.

Each reference pattern 32 is generated from a known reference object 54 in the same manner as the measured pattern 26 is generated for the sampled object 22. In other words, each measured pattern 26 has a unique data file of nano values associated therewith which is generated based on the spectral content of a selected region of the reference object 54. Preferably, each reference pattern 32 is generated and stored on the database 60 by a source or entity related to the reference object 54 using a reference generator apparatus 61 having a spectrum measuring device 63 and a computer 65 operating a pattern generator program. The spectrum measuring device 63 and the computer 65 are constructed and function in the same manner as the spectrum measuring device 14 and the computer 18 described above, therefore no further discussion is deemed necessary to teach one skilled in the art how to make and use the spectrum measuring device 63 and computer 65 operating the pattern generator program. However, the present invention also contemplates that reference patterns 32 can also be generated and provided to the spatial analysis software via the spectrum measuring device 14 and the computer 18 in a similar manner as the sampled pattern 26.

The database 60 of reference patterns 32 can be stored locally or remotely, for example on a server assessable via the internet and a website interface. However, although the system 10 is shown in FIG. 1 as including the at least one database 60, the present invention also contemplates that one or more reference patterns 32 can be directly stored on and provided to the spatial analysis software via a local memory location of the computer 18 or via an external storage medium (e.g., via a disk, CD, or internet download).

If more than one reference pattern 32 is available in the database 60 for comparison, the spatial analysis software can search sequentially through the database 60 until a match is determined, or the spatial analysis software can search the entire database and designate any determined matches, or a “best case” match, as a matching reference pattern 32. However, the measured pattern 26 can also be directly compared against a specific or expected reference pattern 32, in which case a search for a matching reference pattern 32 may not be necessary.

Information produced from scanning and/or comparing the measured pattern 26 and at least one reference pattern 32 is then utilized by the spatial analysis software and/or user to authenticate the sampled object 22 (as discussed in further detail below). In one embodiment, if the measured pattern 26 matches a compared reference pattern 32, then the match indicates that the sampled object 22 from which the measured pattern 26 was generated is likely to be the same object or of the same quality or origin as the reference object 54 from which the matching reference pattern 32 was generated.

In one embodiment, to determine whether a match exists between the measured pattern 26 and one reference pattern 32, the spatial analysis software compares the nano values and amplitudes (i.e., the number of times a certain nano value is repeated) associated with the measured pattern 26 against the nano values and amplitudes associated with the reference pattern 32. Preferably, when a comparison between one measured pattern 26 and one reference pattern 32 is performed (as described above), the dimensions and location of the selected region from which the reference pattern 32 was generated is the same as or correlates to the dimensions and location of the selected region 30 from which the measured pattern 26 was generated. Furthermore, the selected regions are preferably of smaller dimensions so that the data files for the measured patterns 26 and reference patterns 32 are at a size to minimize bandwidth requirements and maximize performance of the system 10.

Preferably, the “match” determination performed by the spatial analysis software is within some set tolerance level to allow for acceptable discrepancy thresholds. Any discrepancies found during the comparison are recorded by the spatial analysis software. If the discrepancies are within some predetermined threshold, then a match is deemed to exist between the measured pattern 26 and the reference pattern 32. Generally, the threshold limitations will depend on the accuracy and analysis time requirements for the system 10. The threshold limitations can be predetermined or alternatively can be set by the user, e.g., via the input device connected to the computer 18.

When discrepancies are found, the spatial analysis software can also indicate a “confidence level” relating to the match determination, for example by displaying a graphical and/or numerical representation of a percentage indicative of the discrepancies detected (as shown by way of illustration in FIG. 9 and represented by the reference numeral 70, and in FIG. 13 and represented by the reference numeral 72).

One advantage of the innovative concept of the present invention is that because multiple reference patterns 32 can be associated with different locations of the reference object 54, the location of the selected region 30 of the sampled object 22 can be varied automatically by the spatial analysis software, or manually by the user, to prevent “cracking” of the system 10, i.e., to prevent the location of the selected region 30 from being easily anticipated. Also, multiple selected regions 30 on the sampled object 22 can be analyzed to insure further accuracy, provided time restraints are met.

Each reference pattern 32 further has identity information associated therewith. The identity information can be directly included in the data file for the reference pattern 32 and/or indirectly retrievable by the spatial analysis software from a local or remote memory location or database. For each reference pattern 32, the associated identity information generally includes information relating to the identity or other characteristics of the reference object 54 from which the reference pattern 32 was generated, the reference pattern 32 itself, and/or a source of the reference object 54 or reference pattern 32. For example, the identity information can be indicative of: 1) a name or title corresponding to the reference object 54 and/or the source of the reference object 54, 2) the physical characteristics or features of the reference object 54 and/or the source of the reference object 54, 3) the location of origination or residence of the reference object 54 and/or the source of the reference object 54, 4) the name and location of the source that created the reference pattern 32, 5) the location and dimensions within the reference object 54 from which the reference pattern 32 was generated, a file name or number assigned to the reference pattern, etc.

For example, if the reference object 54 is a photograph of a person, the identity information can include the name, address, date and place of birth, social security number, height, weight, eye and hair color, race, citizenship, etc., of the person photographed, as well as the date the photograph was produced or received, the name of the entity creating the reference pattern 32 for the photograph, a number code assigned to the reference pattern 32, etc. As another example, if the reference object 54 is a product, the identity information can include the name of the product, a serial or batch number associated with the product, the materials/ingredients in the product, the dimensions and coloration of the product, the date the product was produced, etc., as well as the name and address of the company that produced the product and/or generated the reference pattern 32, the date the reference pattern 32 was generated, a number code assigned to the reference pattern 32, etc.

The identity information associated with any reference pattern 32 that is determined to match the measured pattern 26 can be used to further authenticate the sampled object 22 associated with the measured pattern 26. In one embodiment, when a match between the measured pattern 26 and at least one reference pattern 32 is determined, the identity information associated with the matching reference pattern 32 (and thus the related reference object 54) is compared against identity information associated with the sampled object 22, which generally includes information relating to the identity or other characteristics of the sampled object 22 and/or a source of the sampled object 22. If the identity information associated with the sampled object 22 is substantially the same as or substantially corresponds to at least a portion of the identity information associated with the reference object 54, then the sampled object 22 is deem authentic. In other words, if the identity information from the two sources are substantially the same or substantially correspond, then the sampled object 22 is deemed to be the original reference object 54 or of the same quality or origin as the reference object 54 from which the matching reference pattern 32 was generated.

However, the present invention also contemplates that the match determination of the measured pattern 26 to one reference pattern 32 may be sufficient for authentication purposes. In other words, comparison of the identity information associated with the measured pattern 26 and the matching reference pattern 32 is not necessary, but is preferred for further accuracy. Such an embodiment where identity information is not analyzed may be preferred when a specific expected reference pattern 32 (or a select number of expected reference patterns 32) is provided to the spatial analysis software for comparison.

The comparison to determine the authenticity of the sampled object 22 can be performed by the spatial analysis software if the identity information associated with the sampled object 22 is provided, for example from the entering or scanning of a label, bar code or printed disclosure associated with the sampled object 22, so that the spatial analysis software can receive directly and/or retrieve indirectly the identity information associated with the sampled object 22. The spatial analysis software can then indicate to the user via the at least one output device whether the identity information of the sampled object 22 substantially corresponds to the identity information of the reference object 54 (as shown for example by way of illustration in FIG. 9 and represented by the reference numeral 78, and in FIG. 13 and represented by the reference numeral 80). Additionally, the comparison to determine the authenticity of the sampled object 22 can be performed by a human observer after receiving output indicative of the identity information associated with the reference object 32 from the spatial analysis software via the at least one output device.

Furthermore, it should be understood that the identity information associated with the reference patterns 32 can be used to specify a particular reference pattern 32, or narrow the search within a database of various reference patterns 32, to which the measured pattern 26 is to be compared by the spatial analysis software. For example, as discussed above, when a comparison is made, preferably the dimensions and location of the selected region 58 from which the reference pattern 32 was generated is the same as or correlates to the dimensions and location of the selected region 30 from which the measured pattern 26 was generated. As such, if the database collection of reference patterns 32 which are accessible by the spatial analysis software contains reference patterns 32 of various locations and dimensions, identity information for the reference patterns 32 relating to these characteristics can be used as filter criteria by the spatial analysis software. As another example, if the user knows at least a portion of the identity information of the reference pattern 32 to be used for the comparison (e.g., the file name or number assigned to the reference pattern 32 or a name of the reference object 54 associated with the reference pattern 32) the user can provide the known portion of the identity information to the spatial analysis software via the input device 38 for use as filter criteria.

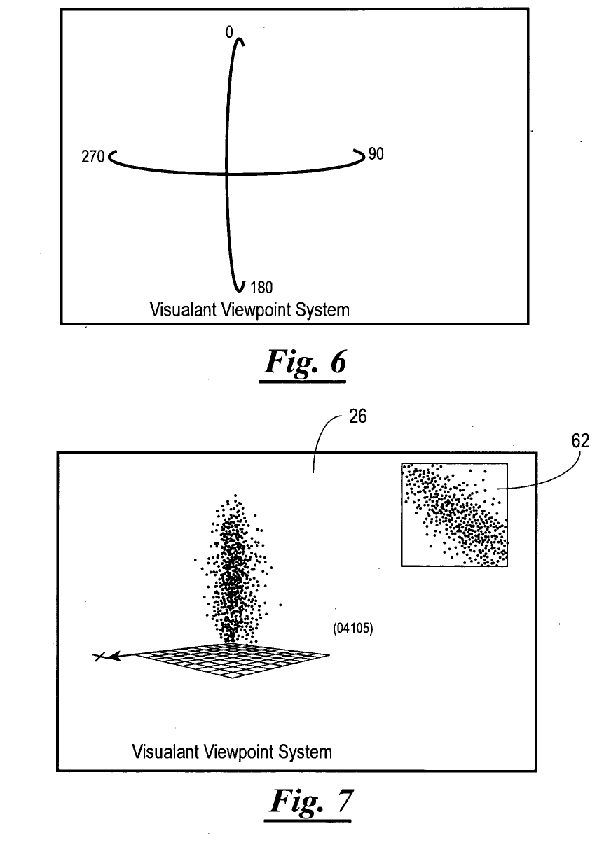

It is important to note that because each measured pattern 26 and reference pattern 32 have three dimensional coordinates, as well as a fourth dimensional amplitude value (as derived from the number of repeated nano values), another innovative and advantageous feature of the present invention is that another comparison level can be utilized by spatial analysis software to determine the authenticity of the sampled object 22. By “observing” or analyzing the measured pattern 26 and reference pattern 32 with reference to a particular angle or viewpoint in the coordinate system, a plurality of distinct and unique secondary patterns (referred to as view keys herein) can be generated for each measured pattern 26 and reference pattern 32. In one embodiment, an “imaginary camera” or analysis viewpoint is moved around within the XYZ color space in which the nano values are modeled. The analysis viewpoint can be for example moved along a two point coordinate system, which ranges from 0 to 360 units for a longitude direction and a latitude direction, as represented pictorially in FIG. 6.

As such, a view key 62 for the sampled object 22 and a view key 64 for the reference object 54, which are derived for the same coordinate viewpoint, can then be compared on a more localized level to determine whether a match exists. Further, various view keys 62 and 64 can be analyzed multiply and/or varied to provide another level of analysis, as well as another level of security for the system 10. Also, because the view keys 62 and 64 contain less values than the measured pattern 26 or reference pattern 32 from which they are derived, i.e., have a smaller data file associated therewith, individual analysis times can be decreased. Further, overall analysis time can also be decreased while maintaining accuracy by first performing a match determination for the measured pattern 26 with a high discrepancy tolerance level to find “rough matches” within a database of reference patterns 32, and then secondly performing a match determination with a low discrepancy tolerance level using one or more view keys 64 generated from the more limited number of matching reference patterns 32.

For either the measured pattern 26 or the reference pattern 32, the generation of one or more view keys is similar. Therefore, for purposes of brevity and clarity, only the generation of one view key 62 for the measured pattern 26 is described in more detail below. In one embodiment, each view key 62 is associated with a unique analysis viewpoint defined by a particular set of longitudinal and latitudinal coordinates. The view key 62 is generated by converting the nano values associated with the measured pattern 26 to viewpoint values based on the analysis viewpoint coordinates.

Preferably, each view key 62 and 64 is not generated until the user manually, or the spatial analysis software automatically, selects the analysis viewpoint coordinates for comparison. However, a plurality of view keys 62 and 64 can be generated for each measured pattern 26 and reference pattern 32, respectively, and stored in a database accessible by the spatial analysis software. Once the analysis viewpoint coordinates are defined, then the view key 62 and 64 based on that analysis viewpoint are generated or selected for the measured pattern 26 and reference pattern 32, respectively. The corresponding view keys 62 and 64 are then compared against each other to determine whether the view key 62 matches the view key 64 (and thus indicate whether the measured pattern 26 matches the reference pattern 32).

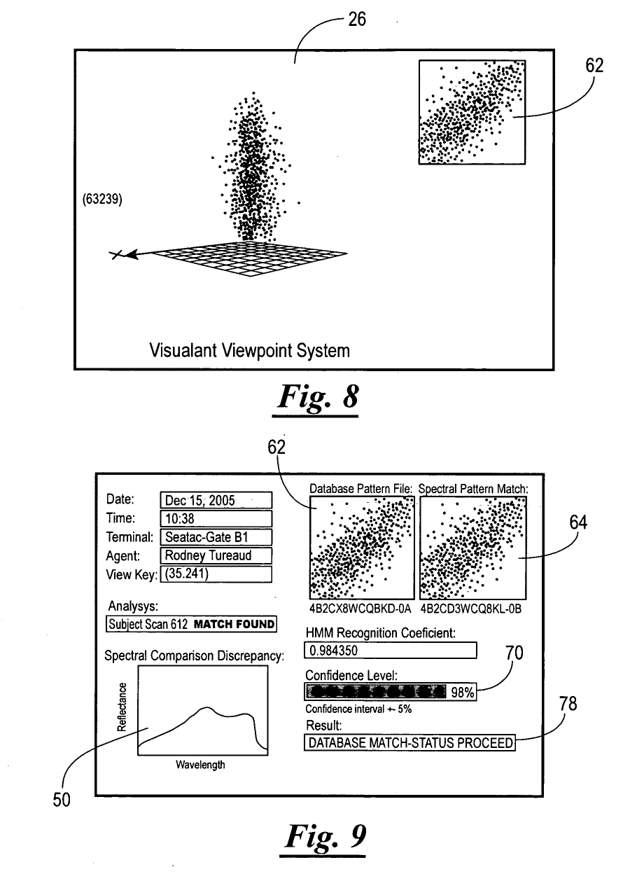

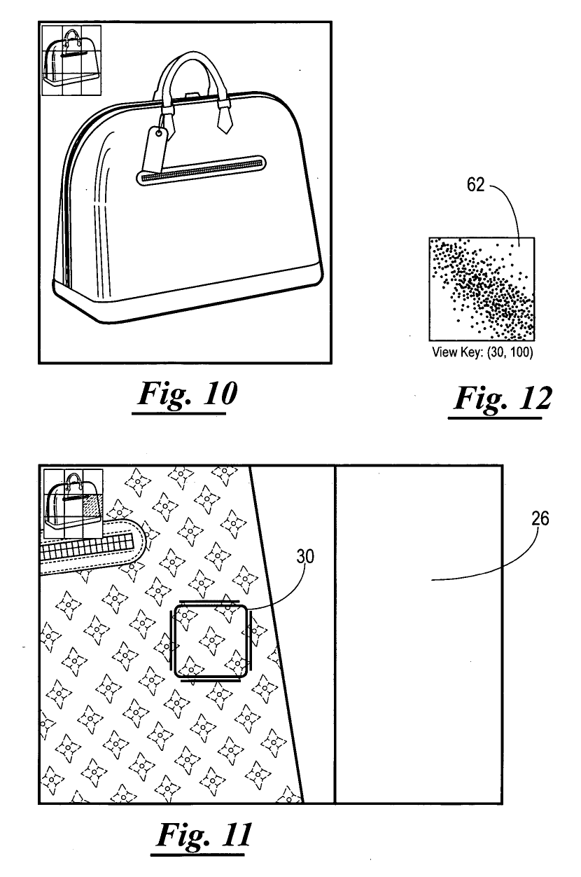

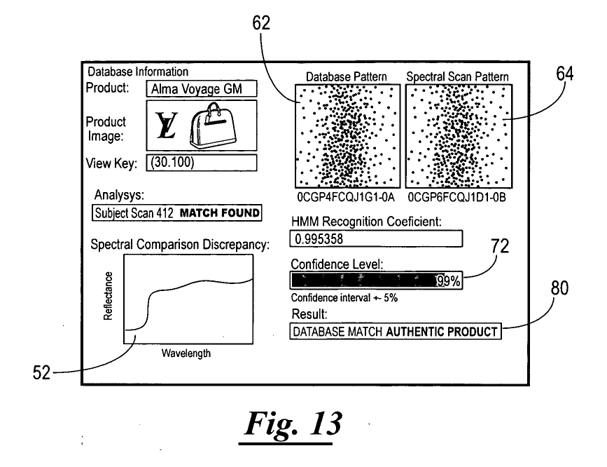

Further, the view key 62 for the sampled object 22 and the view key 64 for the reference object 54 used for comparison can be displayed graphically to the user in a manner similar to the graphical representation of the measured pattern 26 as described above. In one embodiment, a two-dimensional graphical representation of the view key 62 for the sampled object 22 is formed by plotting the viewpoint values associated with the view key 62 in an x-y coordinate system, as shown for example in FIGS. 7-9, and 12-13. Preferably, the amplitude information is maintained and depicted visually to the user by the color of the plotted viewpoint value. A similar two-dimensional and colored graphical representation can also be displayed for the view key 64 for the reference object 54, as shown for example in FIGS. 9 and 13.

The comparison of the view key 62 associated with the sampled object 22 and the view key 64 associated with the reference object 54 is similar to the comparison process for the measured pattern 26 and the reference pattern 32 discussed above. Therefore, for purposes of brevity, the comparison process is described summarily below. The spatial analysis software compares the viewpoint values and amplitudes associated with the view key 62 for the measured pattern 26 against the viewpoint values and amplitudes associated with the corresponding view key 64 for the reference pattern 32. Any discrepancies found during the comparison are recorded by the spatial analysis software. If the discrepancies are within some predetermined threshold, then a match is deemed to exists between the view key 62 and the view key 64, and thus indicate a match between measured pattern 26 and the reference pattern 32. Once a match is determined, the authentication process described in detail above can be performed based on the identity information of the corresponding measured pattern 26 and matching reference pattern 32 to further determine the authenticity of the sampled object 22.

### EXAMPLE APPLICATIONS

The object authentication system 10 of the present invention can be used in a multitude of applications. For example, some of the applications that the system 10 can be used for include document authentication, product authentication and quality control. Examples of such applications and embodiments are set forth hereinafter. It is to be understood that the examples are for illustrative purposes only and are not to be construed as limiting the scope of the invention as described herein. The invention is capable of other embodiments, or of being practiced or carried out in various ways.

### Example 1

### ID/Passport Verification

Imagine being able to search a pattern database of passport photos of every U.S. citizen within seconds to confirm their identity. Couple this with being able to change the search patterns for the entire database, for security purposes, in less than thirty minutes. Not only is identification document fraud eliminated but cracking the security code becomes virtually impossible.

The object authentication system 10 can verify a passport (or other identification documentation) as follows:

When a passport application is submitted, a photo is included which will be affixed to a validly issued passport. The photo identifies the person submitting the application. Once the issuing authority determines that a passport is to be issued, the issuing authority will generate and store at least one known reference pattern associated with the photo (the reference object 54 in this example), as well as other identity information relating to the identity of the person to whom the passport is issued, such as the person's name, physical characteristics, address, social security number, etc. (other issuance information can also be included if necessary, such as for example the date of issuance). A data file containing the reference pattern 32 nano values and associated identity information is stored in the database 60 with a plurality of other reference patterns 32 generated by the issuing authority for other validly issued passports. The issued passport containing the photo is then sent to the person who submitted the application.

At a security checkpoint, for example at an airport terminal, a passport is provided by a traveler for identification purposes. The passport (sampled object 22) is provided to the authentication apparatus 14 of the system 10. A region is selected within the passport photo (the sampled object 22 in this example) for which a spectrum measuring device 14 of the authentication apparatus 12 measures the spectral contents, i.e., color information, and outputs information indicative of the same to the computer 18 operating spatial analysis software.

The spectral content information outputted by the spectrum measuring device 14 is provided as input to the spatial analysis software program, which generates a measured pattern for the sampled passport photo, preferably in the XYZ color space, where such measured pattern can be observed from virtually any angle. The measure pattern (or a view key generated therefrom) is compared to the plurality of reference patterns stored in the passport issuing authority's database (or view keys generated therefrom) until a matching reference pattern is found. If a matching reference pattern is not found, then the passport is deemed to be a fraud by the spatial analysis software. If a match is located, identity information associated with the matching reference pattern is analyzed to determine if the identity information for the matching reference pattern substantially corresponds to the identity information associated with the sampled passport photo.

At least a portion of the identity information associated with the sampled passport photo is generally located within the passport, and can be provided to the spatial analysis software for analysis (e.g. by the user entering or scanning the identity information present in the passport), and/or the identity information within the passport can be provided to the human user to perform the comparison. If the identity information associated with the sampled passport photo matches the identity information associated with the matching reference pattern, the passport photo will be deemed an authentic and validly issued passport (i.e., not a forgery) by the spatial analysis software, and the traveler will be permitted to proceed pass the security checkpoint.

Further, it should be understood that the materials used to construct the passport (or other identification documentation materials) can be validated against known spectral or color data. The paper and inks can be checked to determine if the passport itself is a forgery, not just the photo or information printed on the document.

### Example 2

### Document Authentication

The object authentication system 10 can be used to detect forgeries of a document of value, such as money or bank notes, or other sensitive documents operates as follows:

When a document is validly produced, the producing entity generates and stores at least one reference pattern 32 for the original document (the reference object 54 in this example), as well as other identity information relating to the identity or characteristics of the document, such as the date it was produced, a general title for the document, key terms or monetary value, etc. A data file containing the reference pattern 32 nano values and identity information associated with the reference pattern 32 is then delivered or made available to an eligible recipient of the original document.

When the recipient is later presented with a document (sampled object 22), the recipient can use the authentication apparatus 12 of the object authentication system 10 to check the authenticity of the presented document, i.e., to determine whether the presented document is the original document or of the same quality or origin as the original document. It should be understood that if the document is one that is duplicated, such as a dollar bill for example, then only reference patterns for one representative document needs to be used for authentication.

The presented document is provided to a spectrum measuring device 14 of the authentication apparatus 12. A region is selected within the presented document (the sampled object 22 in this example) for which the spectrum measuring device 14 measures the spectral content and outputs information indicative of the same to the computer 18 operating spatial analysis software.

The spectral content information outputted by the spectrum measuring device 14 is provided as input to the spatial analysis software, which generates a measured pattern for the sampled document. The measured pattern (or a view key generated therefrom) is compared to the specific reference pattern 32 previously generated for the original document (or a view key generated therefrom). If the measured pattern does not match the reference pattern 32, then the presented document is deemed a forgery by the spectral analysis software. If the measured pattern matches the reference pattern, then the presented document is deemed authentic by the spectral analysis software and the recipient can accept the presented document.

For further authentication, the identity information associated with the original document can also be compared to identity information associated with the presented document to determine if they substantially correspond. At least a portion of the identity information associated with the presented document is generally located within the document, and can be provided to the spatial analysis software for analysis (e.g. by the user entering or scanning the identity information present in the document), and/or the identity information within the presented document can be provided to the human user to perform the comparison.

### Example 3

### Product Monitoring

The object authentication system 10 can be used for brand protection to verify the authenticity of a product based on the make of its material (e.g., fabric colors) operates as follows:

When a manufacturer mass produces a product, at least one reference pattern 32 for a representative of the product (the reference object 54 in this example) is generated and stored in the reference pattern database 60, as well as identity information associated with the original product, such as the name or style of the product, a serial number, a color description, a size, the manufacturer's name and address, etc.

To determine if the product (sampled object 22) is of the same quality or of the same origin as the original representative product, a distributor or individual consumer can provide the product to be sampled to the authentication apparatus 12 of the object authentication system 10. A region is selected within the sampled product (the sampled object 22 in this example) for which a spectrum measuring device 14 of the authentication apparatus 12 measures the spectral content and outputs information indicative of the same to a computer 18 operating spatial analysis software.

The spectral content information outputted by the spectrum measuring device 14 is provided as input to the spatial analysis software 18, which generates a measured pattern for the sampled product 22. The measured pattern (or a view key generated therefrom) is compared to the reference patterns 32 in the database 60 (or view keys generated therefrom) until a matching reference pattern 32 is found. If a matching reference pattern is not found, then the sampled product 22 is deemed to be a fraud by the spatial analysis software 18. If a match is located, then the identity information associated with the matching reference pattern is analyzed to determine if the identity information for the matching reference pattern substantially corresponds to the identity information associated with the sampled product. At least a portion of the identity information associated with the sampled product 22 is generally located on a label or tag on the product, or observable by a human user, and can be provided to the spatial analysis software 18 for analysis (e.g. by the user entering or scanning the identity information present in the label or tag or obtained from observation), and/or the identity information associated with the matching reference pattern can be provided to the human user to perform the comparison. If the identity information associated with the sampled product 22 matches the identity information associated with the matching reference pattern, the sampled product 22 will be deemed authentic and the purchase and/or distribution of the sampled product 22 can proceed. If the measured pattern does not match the reference pattern 32, then the sampled product 22 is deemed a knock-off or tampered product.

Thus, the system 10 can be utilized for brand protection to verify the authenticity of products based on the make of their fabric colors with the pattern of the original product in database, the system 10 can compare a knock off versus the real product in a matter of minutes by scanning any area of the product for which a database pattern exists. In a preferred embodiment, once the fabric has been scanned, a view key is selected to obtain a pattern file. This pattern file will be compared against a pattern from an authentic fabric sample on our database from the same view key point.

Art forgery is anther area of product verification that the system 10 can be used. That is, spectral data can be taken from one or more regions of a valuable piece of art and this spectral data could be used to authenticate copies or unknown works.

### Quality Control of Manufacturing Process

The object authentication system 10 can be also be used for quality control of manufacturing processes to maintain quality control on practically any manufactured good or the packaging for the good. In this regard, the system 10 would operate as follows:

When a manufacturer mass produces a product, a variety of reference patterns 32 can be taken from the product (reference object 54) at different locations or areas within the manufacturing process. To determine if the manufacturing process is operating properly, readings can be taken from the products (sampled objects 22) during actual manufacturing and compared to the reference patterns 32 to determine whether the manufacturing process is operating to predetermined quality control standards. Depending upon the results of the comparison, the manufacturing process can be shut down or modified (if the comparison shows unacceptable quality control) or subsequent parts of the manufacturing process can be actuated. For example, if the product (sampled object 22) was a loaf of bread being baked within an oven, then readings could be taken of the loaf of bread and compared with the reference patterns 32 until the comparisons indicate the loaf of bread is ready to be removed from the oven.

Although the foregoing invention has been described in some detail by way of illustration and example for purposes of clarity of understanding, it will be apparent to those skilled in the art that certain changes and modifications may be practiced without departing from the spirit and scope thereof, as described herein. For example, multiple readings of the reference object 54 or the sampled object 22 can be taken from different angles using the spectrum measuring devices 63 or 14. This data can be extrapolated to produce a 3-dimensional topographical map of the surface of the reference object 54 or the sampled object 22. Patterns for this data can also be stored and authenticated. This could be extremely useful in some more difficult cases where other methods of validation do not produce distinct enough results.

It is to be understood that the phraseology and terminology employed herein is for purpose of example and description and should not be regarded as limiting.

What is claimed is:

1. An authentication apparatus for authenticating a sampled object, comprising:
a spectrum measuring device measuring a region of the sampled object so as to produce spectral content information identifying the sampled object, the spectral content information including information indicative of colors inside the visible spectrum of the human eye; and
a computer having access to spatial analysis software, the computer receiving the spectral content information identifying the sampled object and providing the spectral content information to the spatial analysis software to generate a unique measured pattern, the spatial analysis software comparing the unique measured pattern with a reference pattern measured from a known reference object, and outputting a signal indicative of a match between the unique measured pattern with the reference pattern within a tolerance level whereby the color of the region of the sampled object is utilized to authenticate the sampled object.

2. The authentication apparatus of claim 1, wherein the spatial analysis software is stored remotely from the computer.

3. The authentication apparatus of claim 1, wherein the spectral content information includes information indicative of electromagnetic frequencies outside the visible spectrum of the human eye, and wherein the spatial analysis software performs a spectral analysis of the electromagnetic frequencies outside the visible spectrum.

4. The authentication apparatus of claim 1, wherein the location and dimensions of the region of the sampled object are controlled by the spatial analysis software.

5. The authentication apparatus of claim 1, wherein the unique measured pattern is in a form of a graphical representation.

6. The authentication apparatus of claim 5, wherein the graphical representation is selected from a group consisting of a one-dimensional graphical representation, a two-dimensional graphical representation, and a three-dimensional graphical representation.

7. A system for authenticating sampled objects, comprising:
a database storing a plurality of reference patterns measured from known reference objects;
a plurality of spectrum measuring devices, each of the spectrum measuring devices measuring a region of respective sampled objects so as to produce spectral content information identifying the sampled objects, the spectral content information including information indicative of colors inside the visible spectrum of the human eye; and
a plurality of computers having access to spatial analysis software, the computer receiving the spectral content information identifying the sampled object and providing the spectral content information to the spatial analysis software to generate a unique measured pattern, the spatial analysis software comparing the unique measured pattern with the reference patterns stored in the database, and outputting signals indicative of matches between the unique measured pattern with the reference pattern within a tolerance level whereby the colors of the regions of the sampled objects are utilized to authenticate the sampled objects.

8. The system of claim 7, wherein the spatial analysis software is stored remotely from the computer.

9. The system of claim 7, wherein the spectral content information includes information indicative of electromagnetic frequencies outside the visible spectrum of the human eye, and wherein the spatial analysis software performs a spectral analysis of the electromagnetic frequencies outside the visible spectrum.

10. The system of claim 7, wherein the location and dimensions of the region of the sampled object are controlled by the spatial analysis software.

11. The system of claim 7, wherein the unique measured pattern is in a form of a graphical representation.

12. The system of claim 11, wherein the graphical representation is selected from a group consisting of a one-dimensional graphical representation, a two-dimensional graphical representation, and a three-dimensional graphical representation.

13. A method for authenticating objects, comprising the steps of:
storing a plurality of reference patterns measured from known reference objects in a database;
measuring regions of sampled objects so as to produce spectral content information identifying the sampled objects, the spectral content information including information indicative of colors inside the visible spectrum of the human eye;
generating unique measured patterns for the spectral content information identifying the sampled objects;
comparing the unique measured patterns with the reference patterns stored in the database; and
outputting signals indicative of matches between the unique measured patterns with the reference patterns within a tolerance level whereby the colors of the regions of the sampled objects are utilized to authenticate the sampled objects.

14. The method of claim 13, wherein the spectral content information includes information indicative of electromagnetic frequencies outside the visible spectrum of the human eye, and wherein the step of generating the unique measured patterns includes the step of performing a spectral analysis of the electromagnetic frequencies outside the visible spectrum.

15. The method of claim 13, wherein the unique measured pattern is in a form of a graphical representation.

16. The method of claim 15, wherein the graphical representation is selected from a group consisting of a one-dimensional graphical representation, a two-dimensional graphical representation, and a three-dimensional graphical representation.
